(19) United States
(12) Patent Application Publication
(10) Pub. No.: US 2022/0383441 A1
(43) Pub. Date: Dec. 1, 2022

(54) SOFTWARE DEFINED AUTONOMOUS RIDE OPTIMIZATION TO FACILITATE A DETERMINISTIC TRANSPORTATION OUTCOME

(71) Applicant: AT&T Intellectual Property I, L.P., Atlanta, GA (US)

(72) Inventor: Satya Vardharajan, San Diego, CA (US)

(21) Appl. No.: 17/333,859

(22) Filed: May 28, 2021

(51) Int. Cl. G06Q 50/30; G06Q 10/06

(52) U.S. Cl. CPC G06Q 50/30; G06Q 10/06315; G05D 1/0088

(57) ABSTRACT

Software defined autonomous ride optimization to facilitate a deterministic transportation outcome is presented herein. Based on a request to transport a subscriber of an autonomous vehicle transportation service from a location to a destination by a subscriber defined arrival time, a system obtains subscriber preferences, autonomous vehicle capabilities, safety profile information, route characteristics, and service provider status. Based on such information, the system generates, via a group of machine learning models corresponding to respective machine learning processes, a group of ride plans and corresponding durations representing respective combinations of terrestrial, aerial, nautical, and space types of transport, by autonomous vehicle(s), of the subscriber from the location to the destination by the subscriber defined arrival time. Further, based on a subscriber selection of one of the ride plans, the system reserves a combination of vehicle types for the selected ride plan and communicates ride plan status to the subscriber.

### TECHNICAL FIELD

The subject disclosure generally relates to embodiments for software defined autonomous ride optimization to facilitate a deterministic transportation outcome.

### BACKGROUND

People utilize smart phone application(s) to hail rides on an ad hoc basis. In the future, it is expected that the unit economics (e.g., cost per mile) of for-hire ride services, whether ad hoc or autonomous-based, shall drop to a point where passengers will primarily depend on such services for their everyday transportation needs. Unfortunately, although a subscriber of a particular for-hire ride service can specify a time for being picked up at a location, various events outside of the subscriber's control, e.g., change in traffic, change in weather conditions, change in service provider vehicle availability, change in route characteristics, and/or other characteristics that can delay the subscriber from getting to a desired destination on-time. Consequently, conventional for-hire transportation technologies have had some drawbacks, some of which are noted with reference to the various embodiments described herein below.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of an autonomous ride optimization environment for facilitating a deterministic transportation outcome, in accordance with various example embodiments;

FIG. 2 illustrates a block diagram including a machine learning component of an autonomous ride optimization system for facilitating a deterministic transportation outcome, in accordance with various example embodiments;

FIG. 3 illustrates a block diagram including an autonomous vehicle reservation component of an autonomous ride optimization system for facilitating a deterministic transportation outcome, in accordance with various example embodiments;

FIG. 4 illustrates a block diagram of an autonomous ride optimization system including an ongoing autonomous transportation monitoring component and a ride plan modification component for facilitating a deterministic transportation outcome, in accordance with various example embodiments;

FIG. 5 illustrates a block diagram including an ongoing autonomous transportation monitoring component and a ride plan modification component for facilitating a deterministic transportation outcome, in accordance with various example embodiments;

FIG. 6 illustrates a block diagram including a ride plan modification component and a docking pod location for facilitating a deterministic transportation outcome via an alternate travel vehicle type and route, in accordance with various example embodiments;

FIG. 7 illustrates a block diagram of an autonomous ride optimization system including a machine learning training component for facilitating a deterministic transportation outcome, in accordance with various example embodiments;

FIG. 8 illustrates a block diagram including a machine learning training component for facilitating a deterministic transportation outcome, in accordance with various example embodiments;

FIG. 9 illustrates a block diagram of an autonomous ride optimization system including a subscriber information policy component and a ride communication component for facilitating a deterministic transportation outcome, in accordance with various example embodiments;

FIG. 10 illustrates a block diagram of a subscriber information policy component of an autonomous ride optimization system communicatively coupled to a ride communication component of the autonomous ride optimization system, which is communicatively coupled to a user interface component of the autonomous ride optimization system, in accordance with various example embodiments;

FIG. 11 illustrates a block diagram of an autonomous ride optimization system including an edge computing platform, a cloud computing platform, a mobile device platform, and wireless/wireline networks for facilitating a deterministic transportation outcome, in accordance with various example embodiments;

FIGS. 12-13 illustrate flow charts of a method associated with facilitating a deterministic transportation outcome via an autonomous ride optimization, in accordance with various example embodiments;

FIG. 14 illustrates a flow chart of a method for diverting a ride plan via a docking pod for facilitating a deterministic transportation outcome via an autonomous ride optimization, in accordance with various example embodiments;

FIG. 15 illustrates a flow chart of a method for establishing a group of machine learning models and training the group of machine learning models to facilitate an improvement of ride plan outcomes of an autonomous ride optimization system, in accordance with various example embodiments; and

FIG. 16 is a block diagram representing an illustrative non-limiting computing system or operating environment in which one or more aspects of various embodiments described herein can be implemented for facilitating a deterministic transportation outcome via an autonomous ride optimization system.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

As described above, conventional for-hire transportation has had some drawbacks with respect to providing corresponding services in a deterministic manner, i.e., getting a subscriber to a desired destination on-time, e.g., due to various events such as traffic accidents and/or construction, inclement weather, service provider vehicle backlog, etc. On the other hand, various embodiments disclosed herein can facilitate a deterministic transportation outcome via software defined autonomous ride scheduling and optimization.

For example, in embodiment(s), an autonomous ride optimization system comprises a processor and a memory that stores executable instructions that, when executed by the processor, facilitate performance of operations by the processor, comprising: in response to obtaining a request for a transportation of a subscriber of an autonomous vehicle transportation service from a source location to a destination by a subscriber defined arrival time, obtaining subscriber preferences of the subscriber (e.g., such preferences associated with a subscriber identity, e.g., name, corresponding to the subscriber), autonomous vehicle capabilities of a group of autonomous vehicles of the autonomous vehicle transportation service, safety profile information, route characteristics of respective routes between the source location and the destination, and service provider status of the autonomous vehicle transportation service.

In turn, the operations further comprise: based on the subscriber preferences, the autonomous vehicle capabilities, the safety profile information, the route characteristics, and the service provider status, generating, via a group of machine learning models corresponding to respective machine learning processes, a group of ride plans and corresponding durations representing respective combinations of terrestrial, aerial, nautical, and space types of transport, by a combination of autonomous vehicles of the group of autonomous vehicles via the respective routes, of the subscriber from the source location to the destination by the subscriber defined arrival time; and sending, via a transportation communication interface of the autonomous ride optimization system, information representing the group of ride plans and the corresponding durations directed to the subscriber to facilitate a selection, based on subscriber input associated with the subscriber identity received via the transportation communication interface, of a ride plan of the group of ride plans to facilitate the transportation of the subscriber from the source location to the destination by the subscriber defined arrival time.

In an embodiment, the operations further comprise: in response to receiving the selection of the ride plan, reserving a combination of the respective combinations of terrestrial, aerial, nautical, and space types of transport to facilitate the transportation of the subscriber from the source location to the destination by the subscriber defined arrival time.

In an embodiment, a method comprises: obtaining, by a system comprising a processor, e.g., an autonomous ride optimization system, a request to transport a subscriber of an autonomous vehicle transportation service from a start location to an end location by a subscriber defined time; based on the request, obtaining, by the system, subscriber preferences associated with a subscriber identity of the subscriber, autonomous vehicle capabilities of a group of autonomous vehicles of the autonomous vehicle transportation service, safety profile information, route characteristics of respective routes between the start location and the end location, and service provider status of the autonomous vehicle transportation service to facilitate the transport of the subscriber from the start location to the end location by the subscriber defined time.

Further, the method comprises: based on the subscriber preferences, the autonomous vehicle capabilities, the safety profile information, the route characteristics, and the service provider status, creating, by the system via a group of machine learning models corresponding to respective machine learning processes, a group of ride plans and corresponding respective ride durations—the group of ride plans comprising respective routes between the start location and the end location and estimated durations of travel along the respective routes, and the respective routes facilitating respective combinations of terrestrial, aerial, nautical, and space types of transport, via at least one autonomous vehicle of the group of autonomous vehicles, of the subscriber from the start location to the end location by the subscriber defined time.

In turn, the method further comprises: sending, by the system via a transportation communication interface of the system, the group of ride plans and the corresponding respective ride durations in a message directed to the subscriber identity to facilitate a selection, via a subscriber device associated with the subscriber identity, of a ride plan of the group of ride plans comprising a route of the respective routes to facilitate the transport of the subscriber from the start location to the end location by the subscriber defined time.

In one embodiment, the method further comprises: in response to receiving, via the transportation communication interface, the selection of the ride plan via the subscriber device, reserving, by the system, respective autonomous vehicles of the group of autonomous vehicles to facilitate the transport of the subscriber from the start location to the end location by the subscriber defined time.

Another embodiment includes a non-transitory machine-readable medium, comprising executable instructions that, when executed by a system comprising a processor (e.g., an autonomous ride optimization system) facilitate performance of operations, comprising: in response to obtaining a request to transport, via an autonomous vehicle transportation service, a subscriber of the autonomous vehicle transportation service from a first location to a second location by a subscriber defined time, obtaining a group of machine learning transportation model inputs comprising subscriber preferences, autonomous vehicle capabilities of a group of autonomous vehicles of the autonomous vehicle transportation service, safety profile information, route characteristics of respective routes between the first location and the second location, and service provider status of the autonomous vehicle transportation service.

Further, the operations comprise: based on the group of machine learning transportation model inputs, generating, via a group of machine learning models generated using different machine learning processes, a group of ride plans and corresponding ride durations representing respective combinations of terrestrial, aerial, nautical, and space types of transport, by a combination of autonomous vehicles of the group of autonomous vehicles via the respective routes, of the subscriber from the first location to the second location by the subscriber defined time; and in response to sending, via a communication interface of the system, the group of ride plans and corresponding ride durations, receiving a selection, via the communication interface, of a ride plan of the group of ride plans to facilitate the transport of the subscriber from the first location to the second location by the subscriber defined time.

In one embodiment, the operations further comprise: in response to receiving, via the communication interface, the selection of the ride plan, reserving respective autonomous vehicles of the at least one autonomous vehicle to facilitate the transport of the subscriber from the first location to the second location by the subscriber defined time and to prevent other subscribers from reserving the respective autonomous vehicles.

Reference throughout this specification to “one embodiment,” “an embodiment,” etc. means that a particular feature, structure, or characteristic described in connection with the embodiment is included in at least one embodiment. Thus, the appearances of the phrase “in one embodiment,” “in an embodiment,” etc. in various places throughout this specification are not necessarily all referring to the same embodiment. Furthermore, the particular features, structures, or characteristics may be combined in any suitable manner in one or more embodiments.

As described above, conventional transportation technologies have had some drawbacks with respect to accounting for unexpected delays caused by changes in traffic, weather conditions, service provider vehicle availability, etc. To address these and other concerns of conventional transportation technologies, various embodiments disclosed herein can facilitate a deterministic transportation outcome with respect to transporting a subscriber of an autonomous vehicle based transportation service from a source location to the destination by a subscriber defined arrival time by utilizing, e.g., a software defined, autonomous ride optimization system.

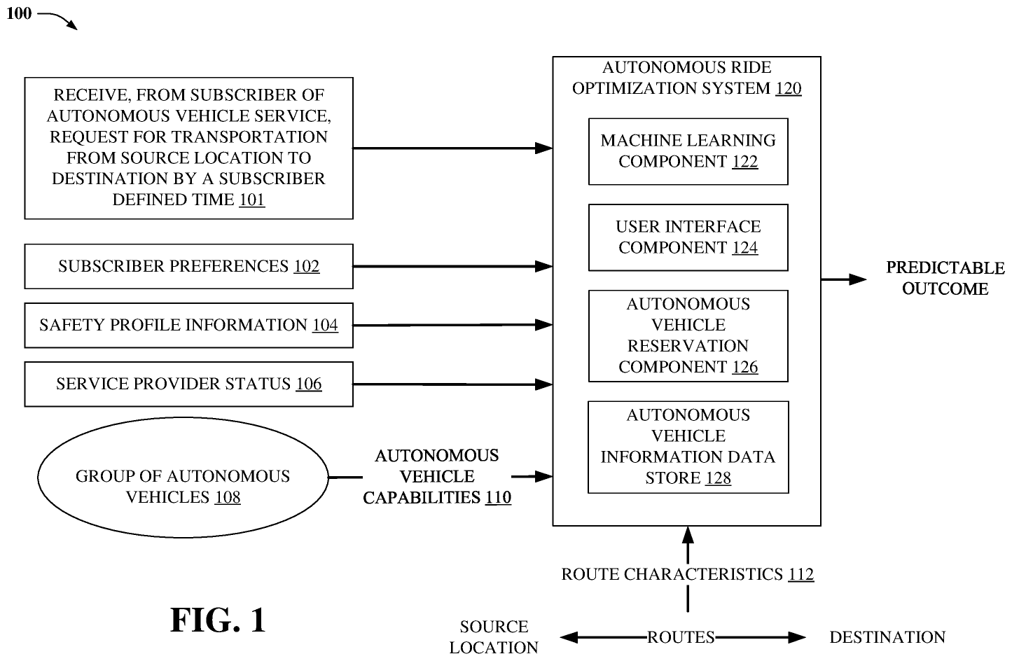

In this regard, and now referring to FIGS. 1-3, a block diagram (100) of an autonomous ride optimization environment for facilitating a deterministic transportation outcome, a block diagram (200) including a machine learning component (122) and a user interface component (124) of an autonomous ride optimization system (120), and a block diagram (300) including an autonomous vehicle reservation component (126) of the autonomous ride optimization system are illustrated, respectively, in accordance with various example embodiments.

As illustrated by FIG. 1, in response to obtaining a request (101) for a transportation of a subscriber of an autonomous vehicle transportation service from a source location to a destination by a subscriber defined arrival time, the autonomous ride optimization system obtains subscriber preferences (102) of the subscriber, safety profile information (104) corresponding to the transportation (e.g., available medical services corresponding to respective routes between the source location and the destination, health characteristics of the subscriber, medical condition(s) of the subscriber, and/or medical based preferences of the subscriber with respect to the available medical services), service provider status (106) of service provider(s), e.g., of ad-hoc transportation services and/or pre-scheduled transportation services of the autonomous vehicle transportation service, autonomous vehicle capabilities (110) of a group of autonomous vehicles (108) of the autonomous vehicle transportation service, and route characteristics (112) of respective routes between the source location and the destination.

In embodiment(s), the subscriber preferences comprise a first preference relating to a cost of the autonomous vehicle transportation service, a second preference relating to a type of an autonomous vehicle of the group of autonomous vehicles, a third preference relating to whether the transportation is to comprise intermediate stops, a fourth preference relating to whether the transportation is to comprise more than one passenger, a fifth preference relating to whether the transportation is to comprise a multi-hop transportation comprising different autonomous vehicles, a sixth preference relating to whether the transportation is to comprise a multi-modal transportation comprising different types of autonomous vehicles, a seventh preference relating to a driving style associated with the subscriber identity, an eighth preference relating to a cabin configuration of the autonomous vehicle, a ninth preference relating to a departure time for the transportation of the subscriber from the source location, a tenth preference relating to the subscriber defined arrival time, and/or an eleventh preference relating to at least a portion of the safety profile information corresponding to the transportation.

In other embodiment(s), the autonomous vehicle information comprises: respective capabilities of the group of autonomous vehicles indicating if and/or whether respective autonomous vehicles of the group of autonomous vehicles are ground-based vehicles, aerial-based vehicles, watercraft-based vehicles, or space-based vehicles; respective availabilities of the respective autonomous vehicles; and/or backlogs of the respective autonomous vehicles referencing delays in the respective availabilities of the respective autonomous vehicles.

In yet other embodiment(s), the safety profile information corresponding to the transportation comprises reliability records of respective autonomous vehicles of the group of autonomous vehicles; traffic safety records of respective segments of the respective routes; respective first availabilities of support services comprising availability of a food service; a gas service, a lodging service, and/or a medical service; and/or respective second availabilities of wireless coverage areas corresponding to the transportation.

In embodiment(s), the group of route characteristics comprises weather conditions corresponding to the respective routes, traffic conditions corresponding to the respective routes, road construction conditions corresponding to the respective routes, and/or pre-scheduled events of interest that have been determined to have an effect on the traffic conditions corresponding to the respective routes.

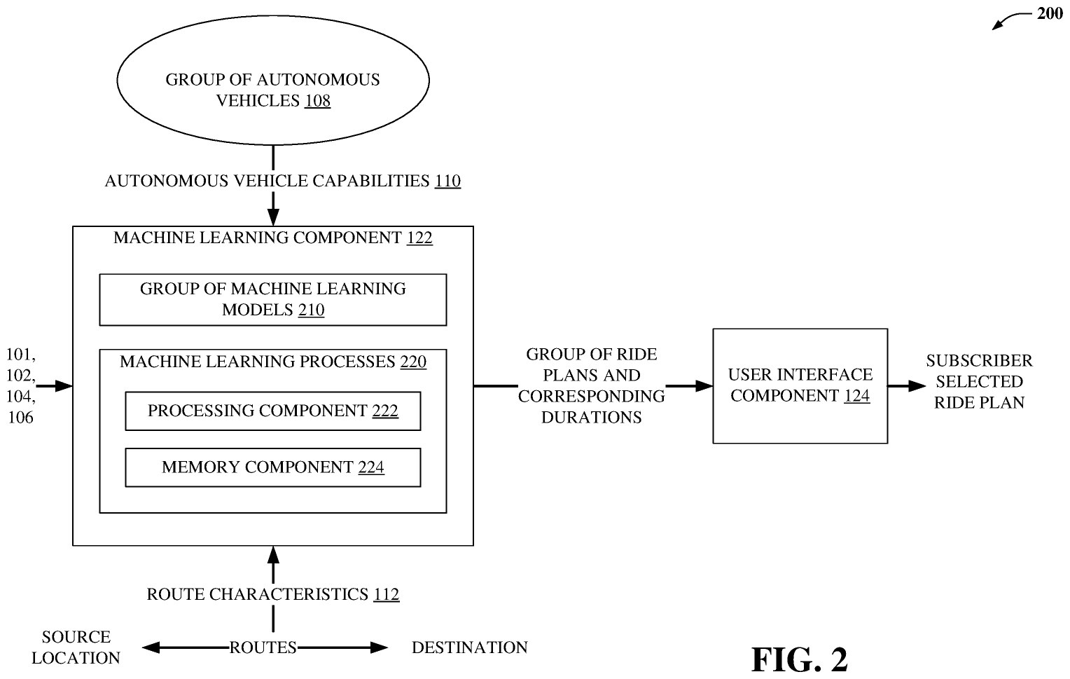

As illustrated by FIG. 2, in other embodiment(s), based on the request, the subscriber preferences, the autonomous vehicle capabilities, the safety profile information, the route characteristics, and the service provider status, the machine learning component generates, via a group of machine learning models (210) corresponding to respective machine learning processes (220), a group of ride plans and corresponding durations representing respective combinations of terrestrial, aerial, nautical, and space types of transport, by a combination of autonomous vehicles of the group of autonomous vehicles via the respective routes, of the subscriber from the source location to the destination by the subscriber defined arrival time.

In yet other embodiment(s), the group of machine learning models comprises an artificial neural network based learning model, a decision tree based learning model, a support vector machine learning model, a linear regression based learning model, and/or a Bayesian network based learning model.

In embodiment(s), the autonomous ride optimization environment (100) comprises an edge compute platform (e.g., see 1102 described below) from which various operations of the autonomous ride optimization are performed via computing components, devices, and/or services that are communicatively coupled, e.g., via various wireline and/or wireless technologies (e.g., long term evolution (LTE) cellular based technologies, fourth generation (G) cellular based technologies, fifth generation (5G) cellular based technologies, 6G, n-th G cellular based technologies, Bluetooth, satellite based technologies, IEEE 802.XX based technologies (e.g., Bluetooth®), WiMAX, WiFi, and/or other wireless technologies) to respective sources of information including vehicle information computing components, devices, and/or services that are located near, approximate to, corresponding to, within a defined distance, e.g., with respect to minimizing computation delay and/or communication latency, from areas where autonomous vehicles are located for gathering, processing, and/or reporting autonomous vehicle capabilities, service provider status, and other information corresponding to the autonomous vehicles among and/or between various other components, devices, and/or services of the autonomous ride optimization system described herein, e.g., from areas where sensors, cameras, or other sensing devices are located with respect to obtaining the safety profile information, the service provider status, and/or the route characteristics.

In another example, the respective sources of information include route information computing components, devices, and/or services that are located near, approximate to, corresponding to, and/or within a defined distance, e.g., with respect to minimizing computation delay and/or communication latency, from routes between the source location and the destination for gathering, processing, and/or reporting route characteristics among and/or between various other component(s) of the autonomous ride optimization system described herein.

Referring again to FIG. 2, in response to generating the group of ride plans and corresponding durations, the machine learning component sends, via a transportation communication interface, e.g., user interface component 124, information representing the group of ride plans and the corresponding durations directed to the subscriber to facilitate a selection, based on subscriber input that is received from the subscriber via the transportation communication interface, of a ride plan of the group of ride plans to facilitate the transportation of the subscriber from the source location to the destination by the subscriber defined arrival time.

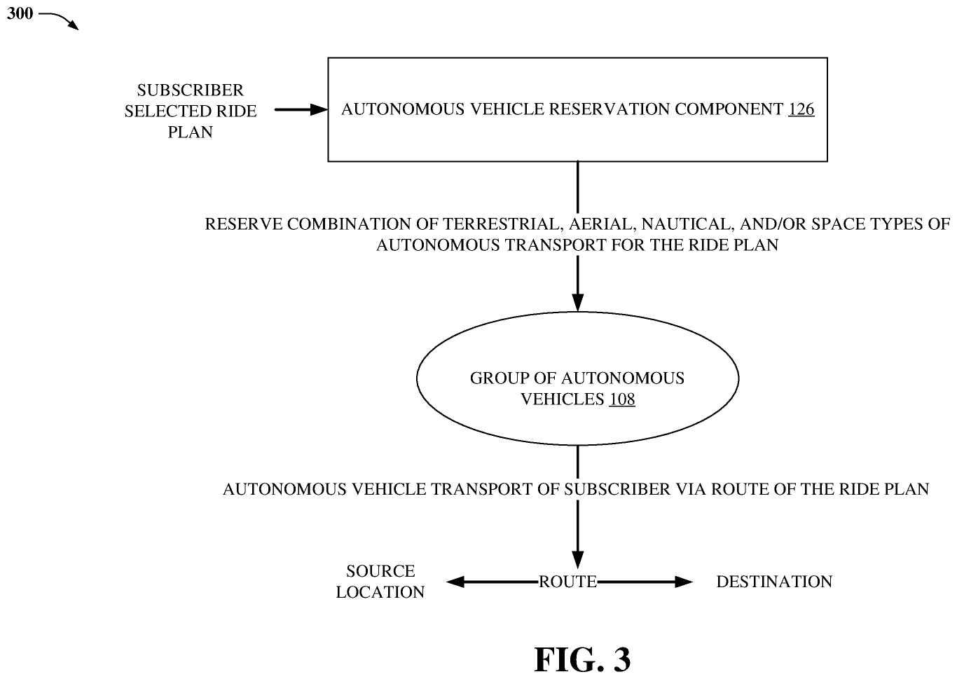

As illustrated by FIG. 3, in response to receiving, from the subscriber, the selection of the ride plan, the autonomous vehicle reservation component reserves a combination of the respective combinations of terrestrial, aerial, nautical, and space types of transport to facilitate the transportation of the subscriber from the source location to the destination by the subscriber defined arrival time. In this regard, in embodiment(s), the autonomous vehicle reservation component can communicate with various ride hailing provider(s) corresponding to the service provider to reserve the combination of terrestrial, aerial, nautical, and space types of transport.

In embodiment(s), once a vehicle reservation is complete, the ride communication component can inform, via the user interface component, the subscriber of the completed reservation. In other embodiment(s), if the autonomous vehicle reservation component cannot reserve a combination of autonomous vehicle(s) for the ride plan, the autonomous vehicle reservation component can send a request, via the user interface component, to the subscriber requesting that the subscriber modify one or more of the subscriber preferences to facilitate generation, by the autonomous ride optimization system, of a new ride plan.

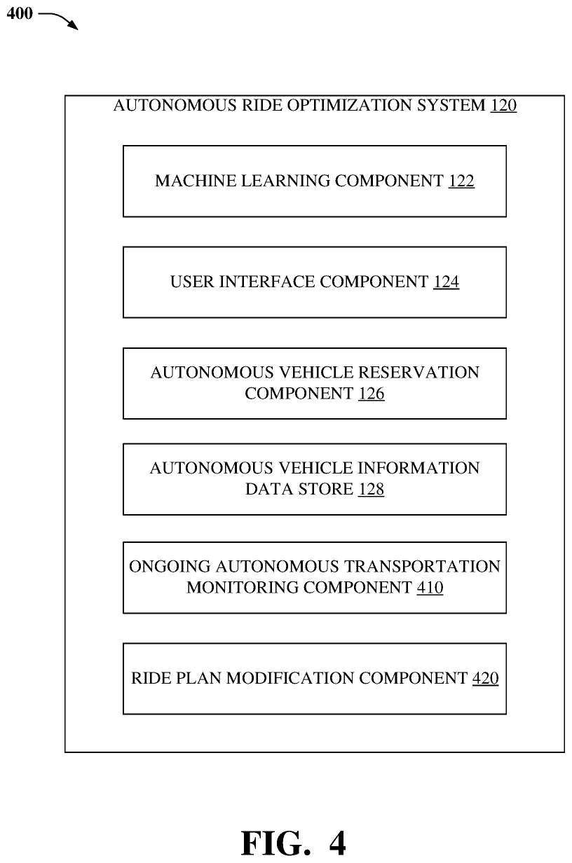

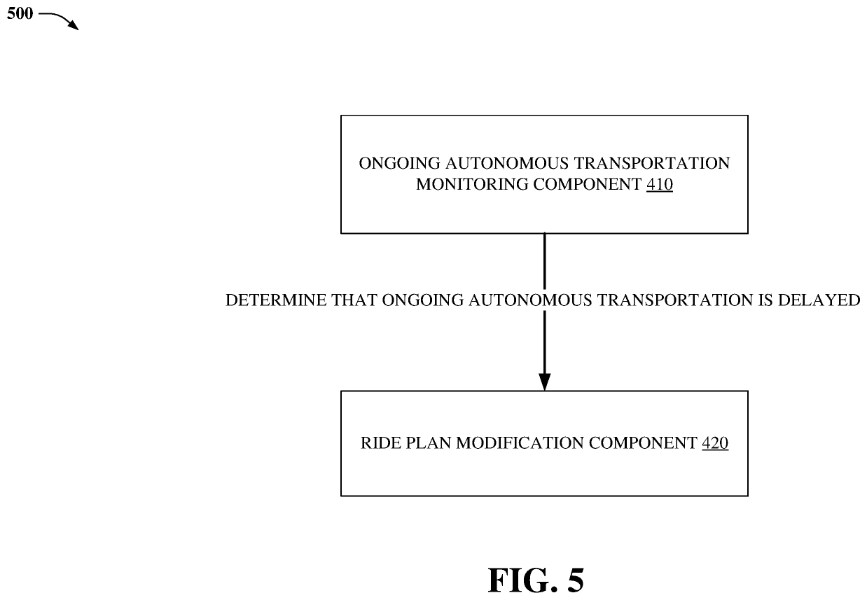

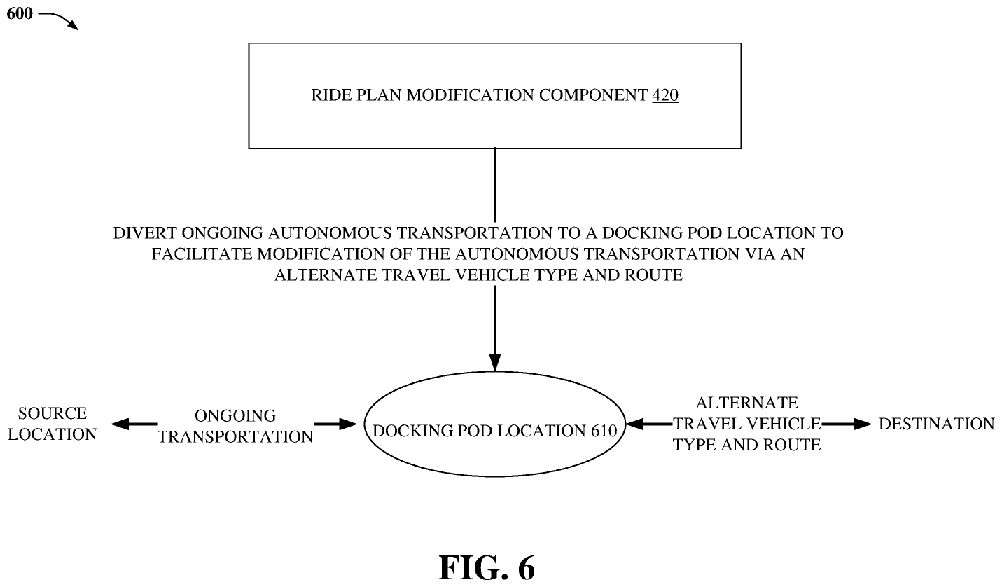

Now referring to FIGS. 4-6, a block diagram (400) of an autonomous ride optimization system (120) including an ongoing autonomous transportation monitoring component (410) and a ride plan modification component (420) for facilitating a deterministic transportation outcome, a block diagram (500) including the ongoing autonomous transportation monitoring component, and a block diagram (600) including the ride plan modification component and a docking pod location (610) are illustrated, respectively, in accordance with various example embodiments.

In this regard, as the transportation becomes an ongoing transportation, e.g., after the subscriber begins to be transported from the source location to the destination location, the ongoing autonomous transportation monitoring component determines whether one or more of the subscriber preferences, the autonomous vehicle capabilities, the safety profile information, the service provider status, or the route characteristics have changed during the ongoing transportation.

Further, in response to such information being determined to have changed, the ongoing autonomous transportation monitoring component determines whether the ongoing transportation has been delayed, e.g., representing that the subscriber will not arrive at the destination by the subscriber defined time. In turn, in response to the ongoing transportation being determined to be delayed, the ride plan modification component modifies a route of the ride plan by diverting the ongoing transportation to a docking pod location that comprises an established location to facilitate modification of a modality of the transportation from a first combination of vehicle types that has been used for a route of the ride plan to a second combination of vehicle types to switch to a different ride plan to facilitate meeting, via the different ride plan, subscriber requirements for the ongoing transportation of the subscriber from the source location to the destination by the subscriber defined arrival time. In this regard, the first type and the second type have been selected from a group of types of autonomous vehicles comprising a terrestrial-based type of autonomous vehicle, an aerial-based type of autonomous vehicle, a nautical-based type of autonomous vehicle, or a space-based type of autonomous vehicle.

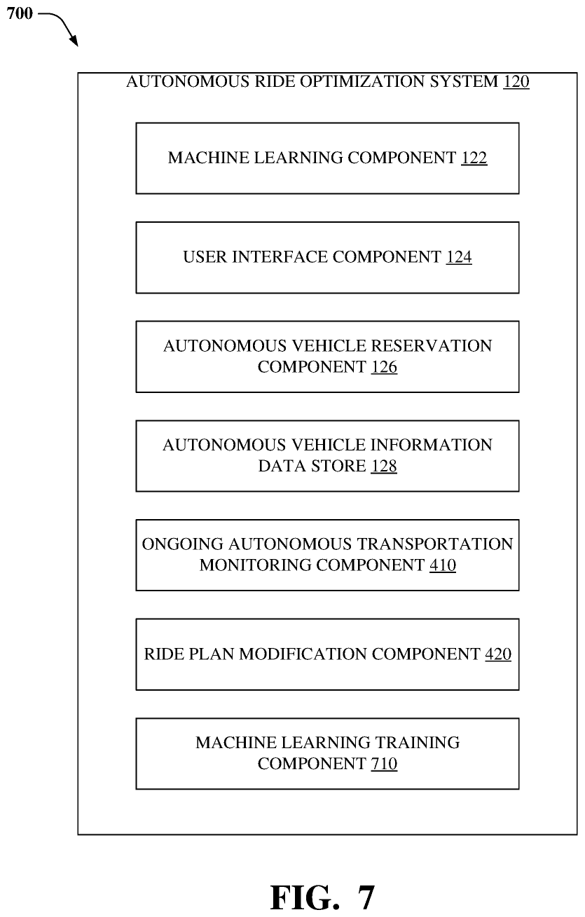

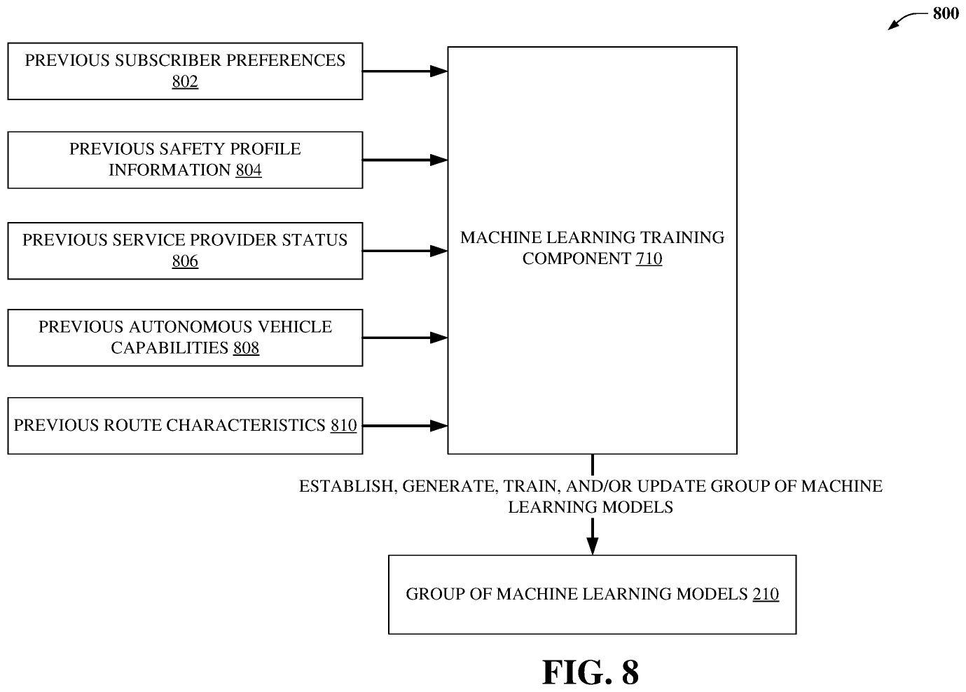

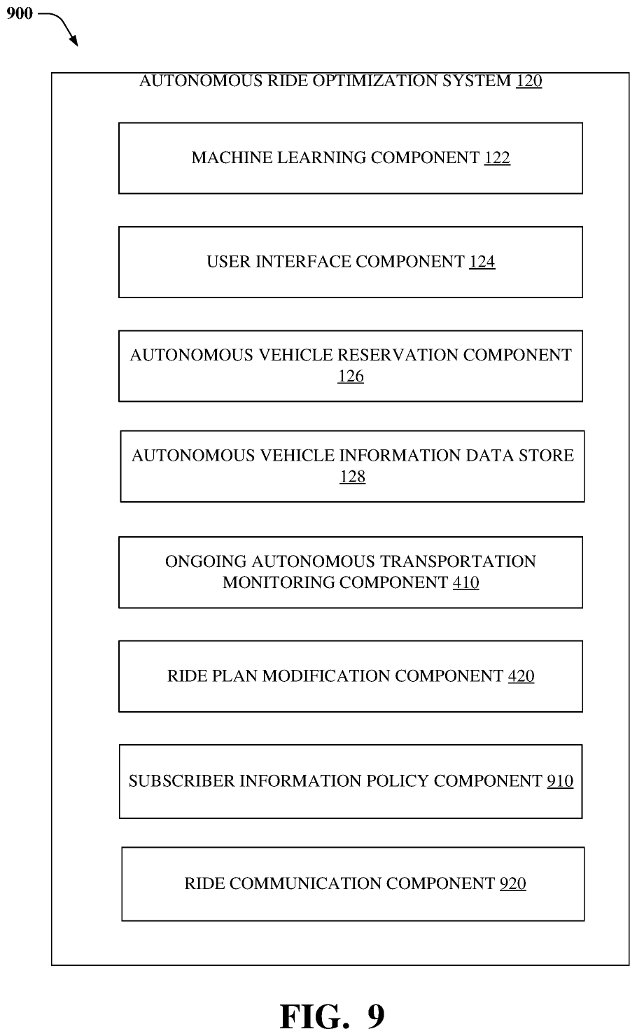

Referring now to FIGS. 7-8, a block diagram (700) of an autonomous ride optimization system (120) including a machine learning training component (710) for facilitating a deterministic transportation outcome, and a block diagram (800) including the machine learning training component are illustrated, respectively, in accordance with various example embodiments.

In this regard, based on an established and/or a specified group of machine learning models, e.g., that have been established and/or specified by system personnel via input(s) of the autonomous ride optimization system, the machine learning component generates, using the established and/or the specified group of machine learning models via defined machine learning processes using respective machine learning inputs of the autonomous ride optimization system, training data that is used by the machine learning component to train and/or modify the established and/or the specified group of machine learning models to improve ride prediction and/or predicted transportation outcomes.

For example, using the established and/or the specified group of machine learning models, the machine learning component, based on previous subscriber preferences, previous autonomous vehicle capabilities, previous safety profile information, previous route characteristics, previous transportation outcomes, and previous service provider status corresponding to the respective routes, generates, via the defined machine learning processes, the training data. In turn, based on the training data, the machine learning component trains and/or modifies the established and/or the specified group of machine learning models to facilitate improved prediction of ride plans and ride plan outcomes corresponding to the ride plan.

In one embodiment, the generating of the group of ride plans comprises predicting, using the established and/or the specified group of machine learning models, the ride plan outcomes, e.g., based on projected durations of respective transportations of the subscriber from the source location to the destination according to the group of ride plans.

In another embodiment, training the group of machine learning models further comprises: based on the subscriber preferences, the autonomous vehicle capabilities, the safety profile information, the route characteristics, determined transportation outcomes corresponding to the respective routes, and the service provider status corresponding to the respective routes, updating the established and/or the specified group of machine learning models to facilitate the improved prediction of the ride plan outcomes.

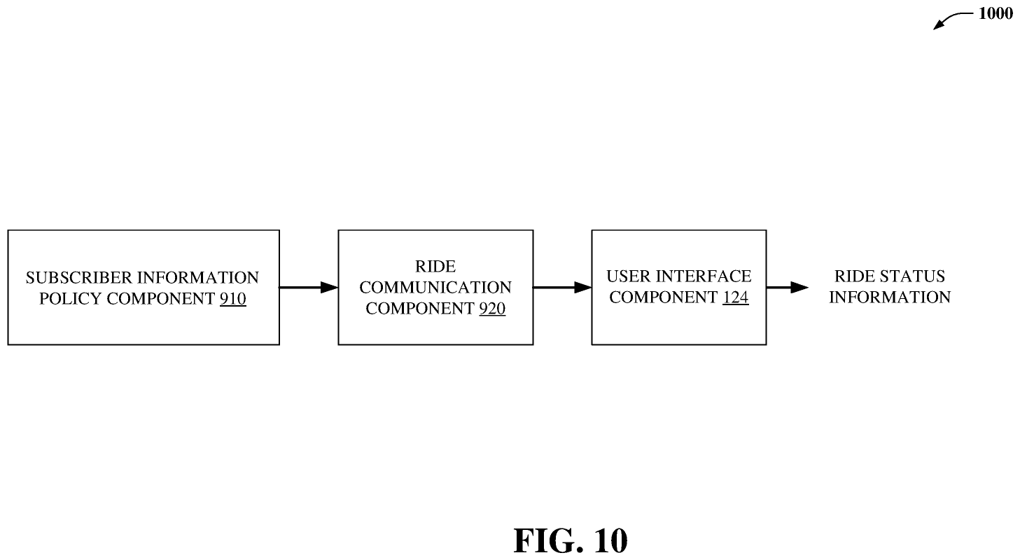

As illustrated by FIG. 10, a subscriber information policy component (910) of the autonomous ride optimization system is communicatively coupled to a ride communication component (920) of the autonomous ride optimization system to facilitate keeping the subscriber informed, via the user interface component, of the subscriber's ride status. In this regard, the subscriber information policy component obtains, e.g., from a data store (e.g., 128), a subscriber communication policy representing subscriber preferences with respect to type(s) of ride status information to be communicated to the subscriber, preferred medium(s) of communication (e.g., short message service (SMS) message(s) and/or email(s)) of such information to the subscriber, and a frequency that such information is to be communicated to the subscriber.

In embodiment(s), the user interface component can receive the subscriber preferences, e.g., via a calendar interface, in which the subscriber can indicate in the calendar their transportation need(s), e.g., with respect to ad-hoc transportation request(s) and/or recurring (e.g., weekly, monthly, yearly, or other defined period of time) transportation requests.

In embodiment(s), the type(s) of ride status information to be communicated to the subscriber can correspond to upcoming and/or planned rides, and include ride plan provider details of a ride plan; descriptions of respective vehicles to be used during the ride plan; a pickup time of the ride plan, another ride plan, or a pre-planned ride plan; a completion/arrival time of the ride plan, another ride plan, or the pre-planned ride plan; and/or a route of the ride plan, another ride plan, or the pre-planned ride plan.

In other embodiment(s), the ride communication component can keep the subscriber informed (e.g., based on a defined period of time) of a description of the ride plan, respective types and capabilities of autonomous vehicle(s) corresponding to the ride plan, the subscriber preferences, capabilities of respective autonomous vehicles corresponding to the ride plan, the safety profile information, route characteristics (e.g., with respect to the subscriber preferences), service provider status, and/or route delay(s).

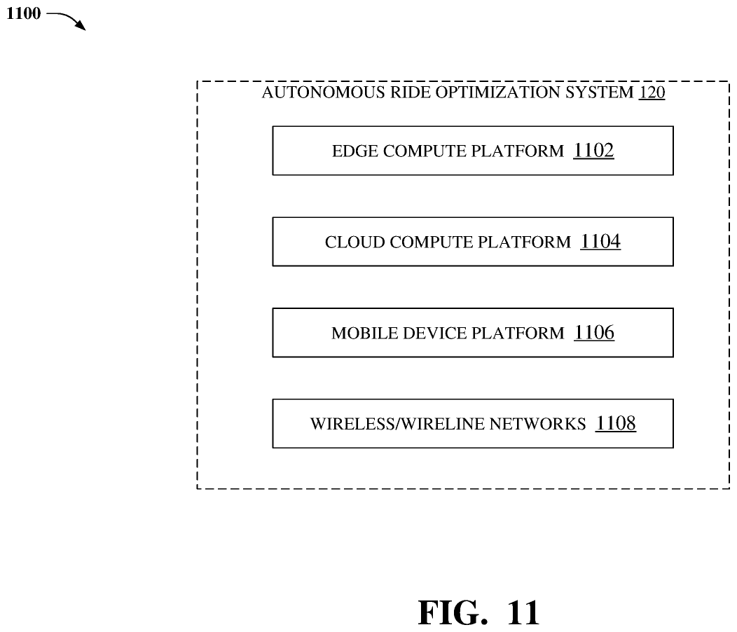

Referring now to FIG. 11, a block diagram (1100) of an autonomous ride optimization system (120) including an edge computing platform (1102), a cloud computing platform (1104), a mobile device platform (1106), and wireless/wireline networks (1108) for facilitating a deterministic transportation outcome is illustrated, in accordance with various example embodiments. As described above, the edge computing platform performs various operations of the autonomous ride optimization via computing components, devices, and/or services that are communicatively coupled, e.g., via various wireless and/or wireline technologies of the wireless/wireline networks, to respective sources of information including vehicle information computing components, devices, and/or services that are located near, approximate to, corresponding to, within a defined distance from areas where autonomous vehicles are located and/or other components, devices, sensors, and/or services of the autonomous ride optimization system for gathering inputs of the autonomous ride optimization system.

Further, various components of the autonomous ride optimization system, e.g., portion(s) of the machine learning component, the user interface component, the autonomous vehicle reservation component, the autonomous vehicle information data store, the ongoing autonomous transportation monitoring component, the ride plan modification component, the machine learning training component, the subscriber information policy component, and/or the ride communication component can be implemented via the cloud computing platform, which includes data storage and computing/processing resources accessible via the Internet. In embodiment(s), the data storage and computing/processing resources can comprise virtual private network (VPN) services, and distributed data storage and processing components, devices, and/or services.

In embodiment(s), the mobile device platform includes wireless communication devices, e.g., cell phones, portable and/or hand-held communication devices, and/or various computing devices corresponding to the wireless/wireline networks that can perform distributed processing and/or data gathering operations, e.g., performed via the autonomous ride optimization system (e.g., via the machine learning component, the user interface component, the autonomous vehicle reservation component, the autonomous vehicle information data store, the ongoing autonomous transportation monitoring component, the ride plan modification component, the machine learning training component, the subscriber information policy component, and/or the ride communication component). For example, the data gathering operations can include obtaining location data of a subscriber, a speed of movement of an autonomous vehicle that is transporting the subscriber, e.g., to assess traffic condition(s) and/or delays of an ongoing transportation corresponding to the ride plan.

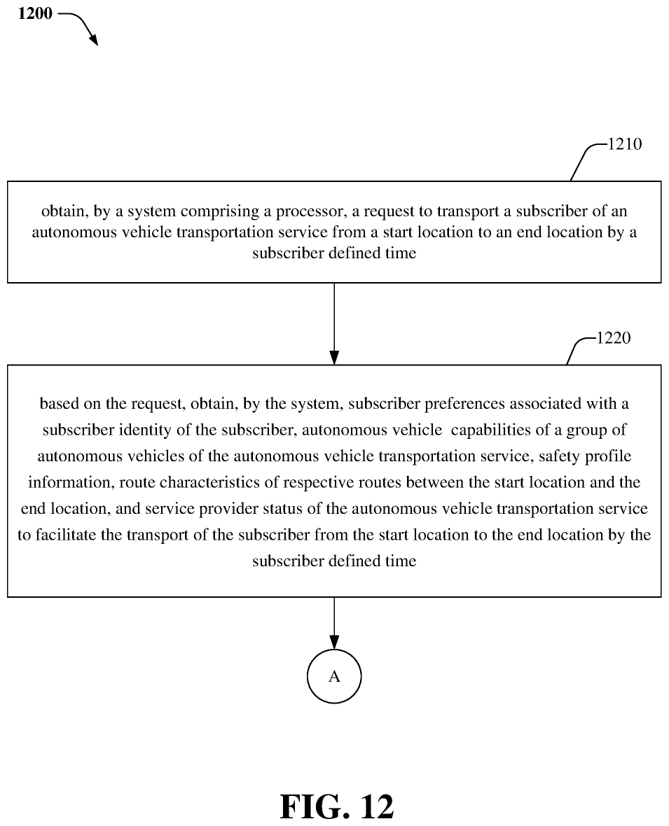

FIGS. 12-14 illustrate methodologies in accordance with the disclosed subject matter. For simplicity of explanation, the methodologies are depicted and described as a series of acts. It is to be understood and appreciated that various embodiments disclosed herein are not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

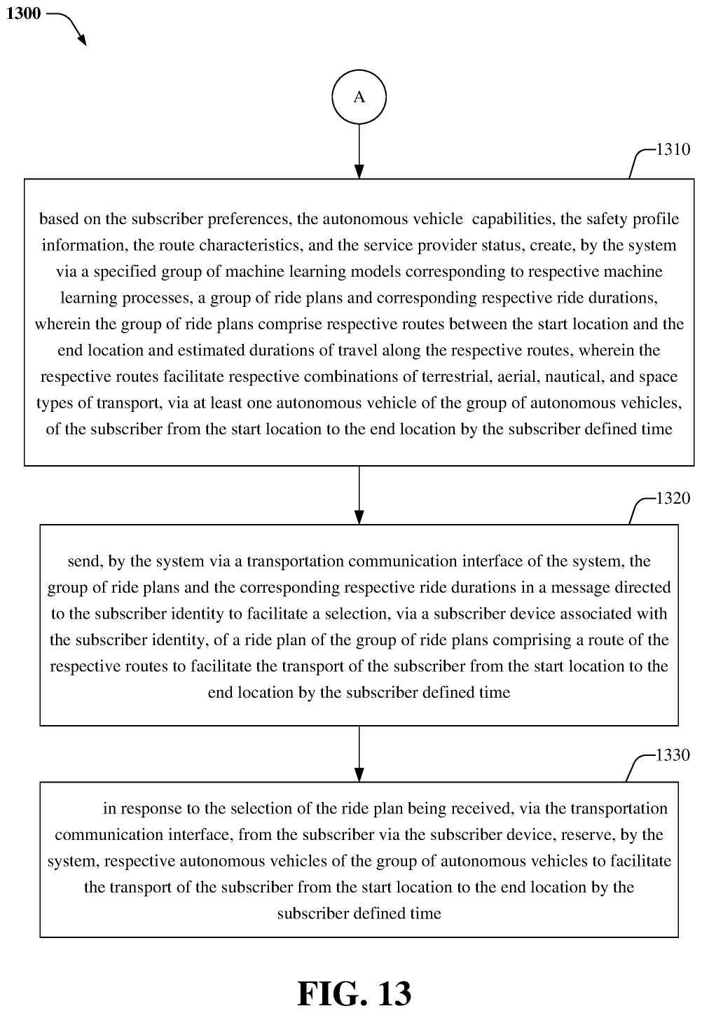

Referring now to FIGS. 12-13, flow charts (1200 and 1300) of a method associated with facilitating a deterministic transportation outcome via an autonomous ride optimization system is illustrated, in accordance with various example embodiments. At 1210, a system (e.g., 120) obtains a request to transport a subscriber of an autonomous vehicle transportation service from a start location to an end location by a subscriber defined time.

At 1220, the system obtains, based on the request, subscriber preferences associated with a subscriber identity of the subscriber, autonomous vehicle capabilities of a group of autonomous vehicles of the autonomous vehicle transportation service, safety profile information, route characteristics of respective routes between the start location and the end location, and service provider status of the autonomous vehicle transportation service to facilitate the transport of the subscriber from the start location to the end location by the subscriber defined time.

At 1310, based on the subscriber preferences, the autonomous vehicle capabilities, the safety profile information, the route characteristics, and the service provider status, the system creates, via a specified group of machine learning models corresponding to respective machine learning processes, a group of ride plans and corresponding respective ride durations. In this regard, the group of ride plans comprise respective routes between the start location and the end location and estimated durations of travel along the respective routes. Further, the respective routes facilitate respective combinations of terrestrial, aerial, nautical, and space types of transport, via at least one autonomous vehicle of the group of autonomous vehicles, of the subscriber from the start location to the end location by the subscriber defined time.

At 1320, the system sends, via a transportation communication interface of the system, the group of ride plans and the corresponding respective ride durations in a message directed to the subscriber identity to facilitate a selection, via a subscriber device associated with the subscriber identity, of a ride plan of the group of ride plans comprising a route of the respective routes to facilitate the transport of the subscriber from the start location to the end location by the subscriber defined time.

At 1330, in response to the selection of the ride plan being received, via the transportation communication interface, from the subscriber via the subscriber device, the system reserves respective autonomous vehicles of the group of autonomous vehicles to facilitate the transport of the subscriber from the start location to the end location by the subscriber defined time.

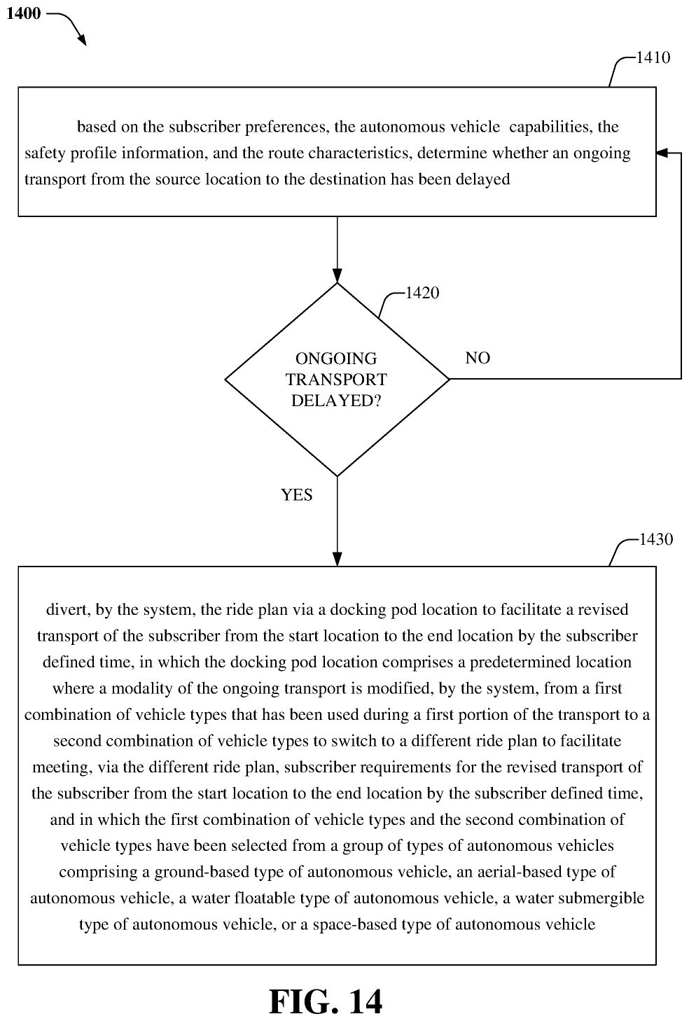

FIG. 14 illustrates a flow chart (1400) of a method for diverting a ride plan via a docking pod for facilitating a deterministic transportation outcome via an autonomous ride optimization system, in accordance with various example embodiments. At 1410, based on the subscriber preferences, the autonomous vehicle capabilities, the safety profile information, and the route characteristics, the autonomous ride optimization system determines whether an ongoing transport from the source location to the destination has been delayed.

At 1420, in response to the ongoing transport being determined to be delayed, flow continues to 1430, at which the autonomous ride optimization system diverts the ride plan via a docking pod location to facilitate a revised transport of the subscriber from the start location to the end location by the subscriber defined time; otherwise flow returns to 1410. In this regard, the docking pod location comprises a predetermined location where a modality of the ongoing transport is modified, by the autonomous ride optimization system, from a first combination of vehicle types that has been used during a first portion of the transport to a second combination of vehicle types to switch to a different ride plan to facilitate meeting, via the different ride plan, subscriber requirements for the revised transport of the subscriber from the start location to the end location by the subscriber defined time. Further, the first combination of vehicle types and the second combination of vehicle types have been selected from a group of types of autonomous vehicles comprising a ground-based type of autonomous vehicle, an aerial-based type of autonomous vehicle, a water floatable type of autonomous vehicle, a water submergible type of autonomous vehicle, or a space-based type of autonomous vehicle.

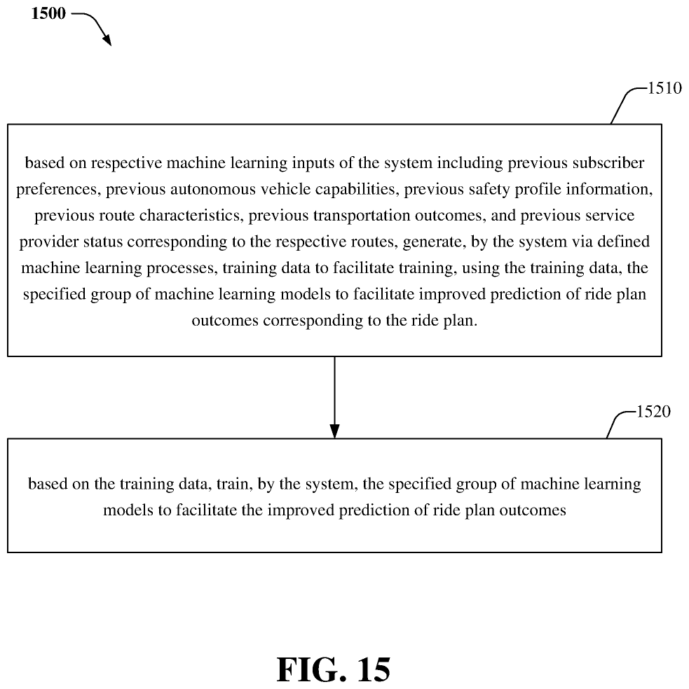

FIG. 15 illustrates a flow chart (1500) of a method for improving ride plan outcomes of an autonomous ride optimization system (e.g., 120), in accordance with various example embodiments. At 1510, based on respective machine learning inputs of the autonomous ride optimization system including previous subscriber preferences, previous autonomous vehicle capabilities, previous safety profile information, previous route characteristics, previous transportation outcomes, and previous service provider status corresponding to the respective routes, the autonomous ride optimization system generates, via defined machine learning processes, training data to facilitate training, using the training data, the specified group of machine learning models to facilitate improved prediction of ride plan outcomes corresponding to the ride plan. In an embodiment, such system can receive input(s), e.g., via machine learning component 122, representing, defining, specifying, establishing, etc. the defined machine learning processes, the respective machine learning inputs, and the specified group of machine learning models.

In turn, at 1520, based on the training data, the autonomous ride optimization system trains the specified group of machine learning models to facilitate the improved prediction of ride plan outcomes.

In this regard, in embodiment(s), the autonomous ride optimization system predicts, using the trained specified group of machine learning models, the ride plan outcomes, e.g., based on determined and/or projected durations of respective transportations of the subscriber from the source location to the destination according to the group of ride plans.

In another embodiment, the autonomous ride optimization system updates, based on the subscriber preferences, the autonomous vehicle capabilities, the safety profile information, the route characteristics, determined transportation outcomes corresponding to the respective routes, and the service provider status corresponding to the respective routes, the specified group of machine learning models to facilitate improved prediction of the ride plan outcomes.

As it employed in the subject specification, the term “processor”, “processing component”, etc. can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “memory component”, “data store”, “data storage”, “memory”, “memory storage”, “system memory”, and substantially any other information storage component relevant to operation and functionality of a component and/or process(es) disclosed herein refer to “memory components,” or entities embodied in a “memory,” or components comprising the memory. It will be appreciated that the memory components described herein can be either volatile memory or nonvolatile memory, or can include both volatile and nonvolatile memory.

By way of illustration, and not limitation, nonvolatile memory, for example, can be included in autonomous vehicle information data store (128), memory component 224, system memory 1606 (see below), hard-disk drive (HDD) 1614 (see below), external storage 1616 (see below), and/or memory storage 1652 (see below). Further, nonvolatile memory can be included in read only memory (ROM), programmable ROM (PROM), electrically programmable ROM (EPROM), electrically erasable ROM (EEPROM), or flash memory. Volatile memory (e.g., 1612) can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

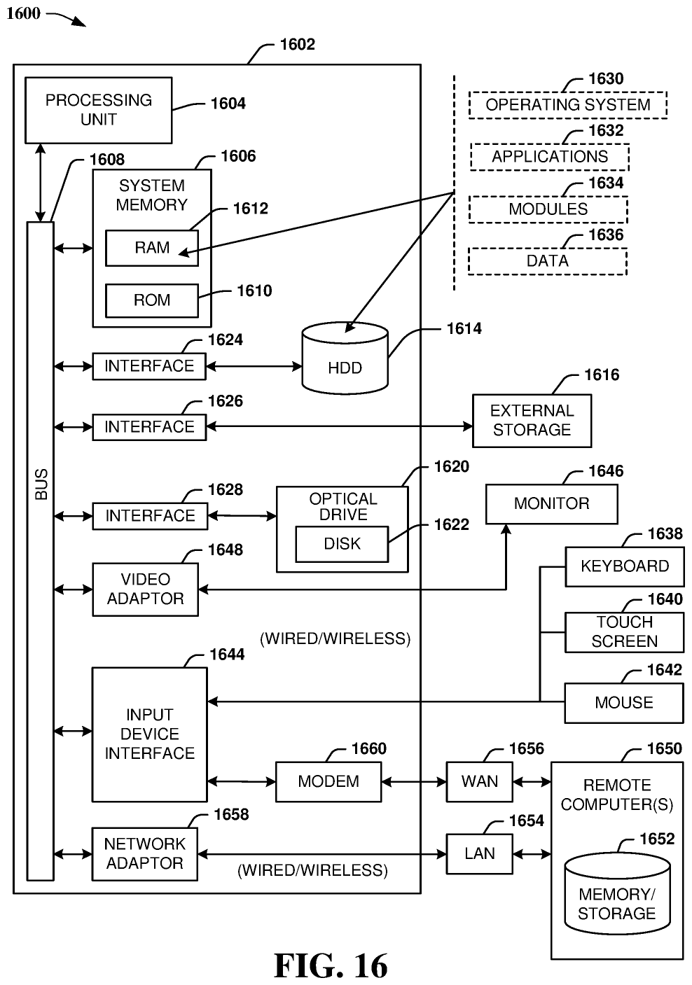

In order to provide additional context for various embodiments described herein, FIG. 16 and the following discussion are intended to provide a brief, general description of a suitable computing environment 1600 in which the various embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that in various embodiments, methods disclosed herein can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices, e.g., via edge computing platform 1102, cloud computing platform 1104, mobile device platform 1106, and/or wireless/wireline networks 1108.

The embodiments described herein can be also practiced in distributed computing environments where certain tasks are performed by remote processing devices that are linked through a communications network, e.g., wireless/wireline networks 1108. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols corresponding to edge computing platform 1102, cloud computing platform 1104, mobile device platform 1106, and/or wireless/wireline networks 1108, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 16, the example environment 1600 for implementing various embodiments of the aspects described herein includes a computer 1602, the computer 1602 including a processing unit 1604, a system memory 1606, and a system bus 1608. The system bus 1608 couples system components including, but not limited to, the system memory 1606 to the processing unit 1604. The processing unit 1604 can be any of various commercially available processors. Dual microprocessors and other multi-processor architectures can also be employed as the processing unit 1604.

The system bus 1608 can be any of several types of bus structure that can further interconnect to a memory bus (with or without a memory controller), a peripheral bus, and a local bus using any of a variety of commercially available bus architectures. The system memory 1606 includes ROM 1610 and RAM 1612. A basic input/output system (BIOS) can be stored in a non-volatile memory such as ROM, erasable programmable read only memory (EPROM), EEPROM, which BIOS contains the basic routines that help to transfer information between elements within the computer 1602, such as during startup. The RAM 1612 can also include a high-speed RAM such as static RAM for caching data.

The computer 1602 further includes an internal hard disk drive (HDD) 1614 (e.g., EIDE, SATA), one or more external storage devices 1616 (e.g., a magnetic floppy disk drive (FDD) 1616, a memory stick or flash drive reader, a memory card reader, etc.) and an optical disk drive 1620 (e.g., which can read or write from a CD-ROM disc, a DVD, a BD, etc.). While the internal HDD 1614 is illustrated as located within the computer 1602, the internal HDD 1614 can also be configured for external use in a suitable chassis (not shown). Additionally, while not shown in environment 1600, a solid state drive (SSD) could be used in addition to, or in place of, an HDD 1614. The HDD 1614, external storage device(s) 1616 and optical disk drive 1620 can be connected to the system bus 1608 by an HDD interface 1624, an external storage interface 1626 and an optical drive interface 1628, respectively. The interface 1624 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. The systems and methods described herein can be implemented utilizing various commercially available operating systems or combinations of operating systems.

Computer 1602 can optionally comprise emulation technologies. For example, a hypervisor (not shown) or other intermediary can emulate a hardware environment for operating system 1630, and the emulated hardware can optionally be different from the hardware illustrated in FIG. 16. In such an embodiment, operating system 1630 can comprise one virtual machine (VM) of multiple VMs hosted at computer 1602. Furthermore, operating system 1630 can provide runtime environments, such as the Java runtime environment or the .NET framework, for applications 1632. Runtime environments are consistent execution environments that allow applications 1632 to run on any operating system that includes the runtime environment. Similarly, operating system 1630 can support containers, and applications 1632 can be in the form of containers, which are lightweight, standalone, executable packages of software that include, e.g., code, runtime, system tools, system libraries and settings for an application.

Further, computer 1602 can be enabled with a security module, such as a trusted processing module (TPM). For instance with a TPM, boot components hash next in time boot components, and wait for a match of results to secured values, before loading a next boot component. This process can take place at any layer in the code execution stack of computer 1602, e.g., applied at the application execution level or at the operating system (OS) kernel level, thereby enabling security at any level of code execution.

Aspects of systems, apparatus, components, and processes explained herein can constitute machine-executable instructions embodied within a machine, e.g., embodied in a computer readable medium (or media) associated with the machine. Such instructions, when executed by the machine, can cause the machine to perform the operations described. Additionally, systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Further, aspects, features, and/or advantages of the disclosed subject matter can be exploited in substantially any wireless telecommunication or radio technology, e.g., IEEE 802.XX technology, e.g., Wi-Fi, Bluetooth, etc.; WiMAX; enhanced GPRS; 3GPP LTE; 3GPP2; UMB; 3GPP UMTS; HSPA; high speed downlink packet access (HSDPA); high speed uplink packet access (HSUPA); LTE-A, GSM, NFC, Wibree, Zigbee, satellite, Wi-Fi Direct, etc.

Further, selections of a radio technology, or radio access technology, can include second generation (2G), third generation (3G), fourth generation (4G), fifth generation (5G), x^{th} generation, etc. evolution of the radio access technology; however, such selections are not intended as a limitation of the disclosed subject matter and related aspects thereof. Further, aspects, features, and/or advantages of the disclosed subject matter can be exploited in disparate electromagnetic frequency bands. Moreover, one or more embodiments described herein can be executed in one or more network elements, and/or within one or more elements of a network infrastructure, e.g., a radio network controller, a wireless access point (AP), or other wireless devices, e.g., of wireless/wireline networks 1108.

Moreover, terms like “user equipment,” (UE) “mobile station,” “mobile subscriber station,” “access terminal,” “terminal”, “handset,” “appliance,” “machine,” “wireless communication device,” “cellular phone,” “personal digital assistant,” “smartphone,” “wireless device”, and similar terminology refer to a wireless device, or wireless communication device, which is at least one of (1) utilized by a subscriber of a wireless service, or communication service, to receive and/or convey data associated with voice, video, sound, and/or substantially any data-stream or signaling-stream; or (2) utilized by a subscriber of a voice over IP (VoIP) service that delivers voice communications over IP networks such as the Internet or other packet-switched networks. Further, the foregoing terms are utilized interchangeably in the subject specification and related drawings.

A communication network, e.g., corresponding to a wireless system (see e.g., 100), for systems, methods, and/or apparatus disclosed herein can include any suitable mobile and/or wireline-based circuit-switched communication network including a GSM network, a time division multiple access (TDMA) network, a code division multiple access (CDMA) network, such as an Interim Standard 95 (IS-95) and subsequent iterations of CDMA technology, an integrated digital enhanced network (iDEN) network and a PSTN. Further, examples of the communication network can include any suitable data packet-switched or combination data packet/circuit-switched communication network, wired or wireless IP network such as a VoLTE network, a VoIP network, an IP data network, a UMTS network, a GPRS network, or other communication networks that provide streaming data communication over IP and/or integrated voice and data communication over combination data packet/circuit-switched technologies.

Similarly, one of ordinary skill in the art will appreciate that a wireless device, e.g., a wireless communication device, a user equipment, etc. for systems, methods, and/or apparatus disclosed herein can include a mobile device, a mobile phone, a 4G, a 5G, etc. cellular communication device, a PSTN phone, a cellular communication device, a cellular phone, a satellite communication device, a satellite phone, a VoIP phone, WiFi phone, a dual-mode cellular/WiFi phone, a combination cellular/VoIP/WiFi/WiMAX phone, a portable computer, or any suitable combination thereof. Specific examples of a wireless system can include, but are not limited to, a cellular device, such as a GSM, TDMA, CDMA, IS-95 and/or iDEN phone, a cellular/WiFi device, such as a dual-mode GSM, TDMA, IS-95 and/or iDEN/VoIP phones, UMTS phones, UMTS VoIP phones, or like devices or combinations thereof.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, magnetic storage devices, e.g., hard disk; floppy disk; magnetic strip(s); optical disk (e.g., compact disk (CD), digital video disc (DVD), Blu-ray Disc (BD)); smart card(s); and flash memory device(s) (e.g., card, stick, key drive); and/or a virtual device that emulates a storage device and/or any of the above computer-readable media.

In accordance with various aspects of the subject specification, artificial intelligence (AI) based systems (e.g., 120) and/or components (e.g., machine learning component 122) can employ classifier(s) that are explicitly trained, e.g., utilizing a group of machine learning models (210) via machine learning processes (220), based on generic training data and/or implicitly trained data, e.g., via observing characteristics of communication equipment, e.g., a gateway, and/or a wireless communication device, by receiving reports from such communication equipment, by receiving operator and/or subscriber preferences, by receiving historical information, by receiving extrinsic information, subscriber preferences (102), safety profile information (104), service provider status (106), autonomous vehicle capabilities (110), route characteristics (112), previous subscriber preferences (802), previous safety profile information (804), previous service provider status (806), previous autonomous vehicle capabilities (808), and/or previous route characteristics (810).

For example, support vector machines can be configured via a learning or training phase within a classifier constructor and feature selection module and/or component (e.g., 122). Thus, the classifier(s) can be used by the AI based system, e.g., the autonomous ride optimization system (120), to automatically learn and perform a number of functions, including, but not limited to, establishing, via defined machine learning processes (220) using respective machine learning inputs of the AI based system, the group of machine learning models (210). Further, based on previous subscriber preferences (802), previous safety profile information (804), previous service provider status (806), previous autonomous vehicle capabilities (808), and/or previous route characteristics (810), the AI based system can train the group of machine learning models (210) to facilitate improved prediction of ride plan outcomes corresponding to a ride plan.

A classifier can be a function that maps an input attribute vector, x=(x1, x2, x3, x4, xn), to a confidence that the input belongs to a class, that is, f(x)=confidence (class). Such classification can employ a probabilistic and/or statistical-based analysis (e.g., factoring into the analysis utilities and costs) to infer an action that a user, e.g., subscriber, desires to be automatically performed. In the case of communication systems, for example, attributes can be information received from access points, services, components of a wireless communication network, etc., and the classes can be categories or areas of interest (e.g., levels of priorities). A support vector machine is an example of a classifier that can be employed. The support vector machine operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., a decision tree based learning model, a linear regression based learning model, support vector machines, neural networks, expert systems, Bayesian belief networks, fuzzy logic, and data fusion engines) can be employed in connection with performing automatic and/or inferred action in connection with the disclosed subject matter.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a processor; and
a memory that stores executable instructions that, when executed by the processor, facilitate performance of operations by the processor, comprising:
in response to obtaining a request for a transportation of a subscriber of an autonomous vehicle transportation service from a source location to a destination by a subscriber defined arrival time, obtaining subscriber preferences associated with a subscriber identity of the subscriber, autonomous vehicle capabilities of a group of autonomous vehicles of the autonomous vehicle transportation service, safety profile information, route characteristics of respective routes between the source location and the destination, and service provider status of the autonomous vehicle transportation service;
based on the subscriber preferences, the autonomous vehicle capabilities, the safety profile information, the route characteristics, and the service provider status, generating, via a defined group of machine learning models corresponding to respective machine learning processes, a group of ride plans and corresponding durations representing respective combinations of terrestrial, aerial, nautical, and space types of transport, by a combination of autonomous vehicles of the group of autonomous vehicles via the respective routes, of the subscriber from the source location to the destination by the subscriber defined arrival time; and
sending, via a transportation communication interface of the system, information representing the group of ride plans and the corresponding durations directed to the subscriber to facilitate a selection, based on subscriber input associated with the subscriber identity received via the transportation communication interface, of a ride plan of the group of ride plans to facilitate the transportation of the subscriber from the source location to the destination by the subscriber defined arrival time.

2. The system of claim 1, wherein the operations further comprise:
in response to receiving the selection of the ride plan, reserving a combination of the respective combinations of terrestrial, aerial, nautical, and space types of transport to facilitate the transportation of the subscriber from the source location to the destination by the subscriber defined arrival time.

3. The system of claim 1, wherein the group of subscriber preferences comprises at least one of:
a first preference relating to a cost of the autonomous vehicle transportation service,
a second preference relating to a type of an autonomous vehicle of the group of autonomous vehicles,
a third preference relating to whether the transportation is to comprise intermediate stops,
a fourth preference relating to whether the transportation is to comprise more than one passenger,
a fifth preference relating to whether the transportation is to comprise a multi-hop transportation comprising different autonomous vehicles,
a sixth preference relating to whether the transportation is to comprise a multi-modal transportation comprising different types of autonomous vehicles,
a seventh preference relating to a driving style associated with the subscriber identity,
an eighth preference relating to a cabin configuration of the autonomous vehicle,
a ninth preference relating to a departure time for the transportation of the subscriber from the source location,
a tenth preference relating to the subscriber defined arrival time, or
an eleventh preference relating to at least a portion of the safety profile information corresponding to the transportation.

4. The system of claim 1, wherein the autonomous vehicle information comprises at least one of:
respective capabilities of the group of autonomous vehicles indicating if respective autonomous vehicles of the group of autonomous vehicles are ground-based vehicles, aerial-based vehicles, watercraft-based vehicles, or space-based vehicles;
respective availabilities of the respective autonomous vehicles; or
backlogs of the respective autonomous vehicles referencing delays in the respective availabilities of the respective autonomous vehicles.

5. The system of claim 1, wherein the safety information corresponding to the transportation comprises at least one of:
reliability records of respective autonomous vehicles of the group of autonomous vehicles,
traffic safety records of respective segments of the respective routes,
respective first availabilities of support services comprising availability of at least one of a food service, a gas service, a lodging service, or a medical service, or
respective second availabilities of wireless coverage areas corresponding to the transportation.

6. The system of claim 1, wherein the group of route characteristics comprises at least one of:
weather conditions corresponding to the respective routes,
traffic conditions corresponding to the respective routes,
road construction conditions corresponding to the respective routes, or
pre-scheduled events of interest that have been determined to have an effect on the traffic conditions corresponding to the respective routes.

7. The system of claim 1, wherein the system comprises an edge compute platform from which the operations are performed.

8. The system of claim 7, wherein the transportation is an ongoing transportation, and wherein the operations further comprise:
based on at least one of the subscriber preferences, the autonomous vehicle capabilities, the safety profile information, the service provider status, or the route characteristics being determined to have changed during the ongoing transportation, determining whether the ongoing transportation has been delayed; and
in response to the ongoing transportation being determined to be delayed, modifying a route of the ride plan by diverting the ongoing transportation to a docking pod location, wherein the docking pod location comprises an established location to facilitate modification of a modality of the ongoing transportation from a first combination of vehicle types that has been used for a route of the ride plan to a second combination of vehicle types to switch to a different ride plan to facilitate meeting, via the different ride plan, subscriber requirements for a revised transportation of the subscriber from the source location to the destination by the subscriber defined arrival time, and wherein the first type and the second type have been selected from a group of types of autonomous vehicles comprising a terrestrial-based type of autonomous vehicle, an aerial-based type of autonomous vehicle, a nautical-based type of autonomous vehicle, or a space-based type of autonomous vehicle.

9. The system of claim 1, wherein the operations further comprise:
training the defined group of machine learning models based on previous subscriber preferences, previous autonomous vehicle capabilities, previous safety profile information, previous route characteristics, previous transportation outcomes, and previous service provider status corresponding to the respective routes.

10. The system of claim 9, wherein training the defined group of machine learning models further comprises:
in response to the defined group of machine learning models being specified, via at least one input of the system, generating, using the defined machine learning models via defined machine learning processes based on respective machine learning inputs of the system, training data to facilitate training, using the training data, the defined group of machine learning models to facilitate improved prediction of ride plan outcomes corresponding to the ride plan; and
based on the training data, training the defined group of machine learning models to facilitate the improved prediction of ride plan outcomes.

11. The system of claim 10, wherein training the defined group of machine learning models further comprises:
based on the subscriber preferences, the autonomous vehicle capabilities, the safety profile information, the route characteristics, determined transportation outcomes corresponding to the respective routes, and the service provider status corresponding to the respective routes, updating the defined group of machine learning models to facilitate the improved prediction of the ride plan outcomes.

12. The system of claim 9, wherein generating the group of ride plans comprises:
in response to training the defined group of machine learning models and based on the subscriber preferences, the autonomous vehicle capabilities, the safety profile information, the route characteristics, and the service provider status, predicting projected durations of respective transportations of the subscriber according to the group of ride plans from the source location to the destination.

13. The system of claim 1, wherein the defined group of machine learning models comprises at least one of an artificial neural network based learning model, a decision tree based learning model, a support vector machine learning model, a linear regression based learning model, or a Bayesian network based learning model.

14. A method, comprising:
obtaining, by a system comprising a processor, a request to transport a subscriber of an autonomous vehicle transportation service from a start location to an end location by a subscriber defined time;
based on the request, obtaining, by the system, subscriber preferences associated with a subscriber identity of the subscriber, autonomous vehicle capabilities of a group of autonomous vehicles of the autonomous vehicle transportation service, safety profile information, route characteristics of respective routes between the start location and the end location, and service provider status of the autonomous vehicle transportation service to facilitate the transport of the subscriber from the start location to the end location by the subscriber defined time; and
based on the subscriber preferences, the autonomous vehicle capabilities, the safety profile information, the route characteristics, and the service provider status,
creating, by the system via a specified group of machine learning models corresponding to respective machine learning processes, a group of ride plans and corresponding respective ride durations, wherein the group of ride plans comprise respective routes between the start location and the end location and estimated durations of travel along the respective routes, wherein the respective routes facilitate respective combinations of terrestrial, aerial, nautical, and space types of transport, via at least one autonomous vehicle of the group of autonomous vehicles, of the subscriber from the start location to the end location by the subscriber defined time, and
sending, by the system via a transportation communication interface of the system, the group of ride plans and the corresponding respective ride durations in a message directed to the subscriber identity to facilitate a selection, via a subscriber device associated with the subscriber identity, of a ride plan of the group of ride plans comprising a route of the respective routes to facilitate the transport of the subscriber from the start location to the end location by the subscriber defined time.

15. The method of claim 14, further comprising:
in response to receiving, by the system via the transportation communication interface, the selection of the ride plan via the subscriber device, reserving, by the system, respective autonomous vehicles of the group of autonomous vehicles to facilitate the transport of the subscriber from the start location to the end location by the subscriber defined time.

16. The method of claim 14, wherein the system comprises an edge compute platform to facilitate
obtaining the request,
obtaining the subscriber preferences, the autonomous vehicle capabilities, the safety profile information, the route characteristics, and the service provider status,
creating the group of ride plans and the corresponding respective ride durations, and
sending the group of ride plans and the corresponding respective ride durations in the message directed to the subscriber entity to facilitate the selection of the ride plan.

17. The method of claim 14, wherein the transport is an ongoing transport, and further comprising:
in response to the ongoing transport being determined, based on the subscriber preferences, the autonomous vehicle capabilities, the safety profile information, and the route characteristics, to be delayed, diverting, by the system, the ride plan via a docking pod location to facilitate a revised transport of the subscriber from the start location to the end location by the subscriber defined time, wherein the docking pod location comprises a predetermined location where a modality of the ongoing transport is modified, by the system, from a first combination of vehicle types that has been used during a first portion of the ongoing transport to a second combination of vehicle types to switch to a different ride plan that is different from the ride plan to facilitate meeting, via the different ride plan, subscriber requirements for the revised transport of the subscriber from the start location to the end location by the subscriber defined time, and wherein the first combination of vehicle types and the second combination of vehicle types have been selected from a group of types of autonomous vehicles comprising a ground-based type of autonomous vehicle, an aerial-based type of autonomous vehicle, a water floatable type of autonomous vehicle, a water submergible type of autonomous vehicle, or a space-based type of autonomous vehicle.

18. The method of claim 14, further comprising:
based on respective machine learning inputs of the system including previous subscriber preferences, previous autonomous vehicle capabilities, previous safety profile information, previous route characteristics, previous transportation outcomes, and previous service provider status corresponding to the respective routes, generating, by the system via defined machine learning processes, training data to facilitate training, using the training data, the specified group of machine learning models to facilitate improved prediction of ride plan outcomes corresponding to the ride plan; and
based on the training data, training, by the system, the specified group of machine learning models to facilitate the improved prediction of ride plan outcomes.

19. A non-transitory machine-readable medium, comprising executable instructions that, when executed by a system comprising a processor, facilitate performance of operations, comprising:
in response to obtaining a request to transport, via an autonomous vehicle transportation service, a subscriber of the autonomous vehicle transportation service from a first location to a second location by a subscriber defined time, obtaining a group of machine learning transportation model inputs comprising subscriber preferences, autonomous vehicle capabilities of a group of autonomous vehicles of the autonomous vehicle transportation service, safety profile information, route characteristics of respective routes between the first location and the second location, and service provider status of the autonomous vehicle transportation service;
based on the group of machine learning transportation model inputs, generating, via a group of machine learning models corresponding to respective machine learning processes, a group of ride plans and corresponding ride durations representing respective combinations of terrestrial, aerial, nautical, and space types of transport, by a combination of autonomous vehicles of the group of autonomous vehicles via the respective routes, of the subscriber from the first location to the second location by the subscriber defined time; and
in response to sending, via a communication interface of the system, the group of ride plans and corresponding ride durations to the subscriber, receiving a selection, via the communication interface, of a ride plan of the group of ride plans from the subscriber to facilitate the transport of the subscriber from the first location to the second location by the subscriber defined time.

20. The non-transitory machine-readable medium of claim 19, wherein the operations further comprise:
sending, via the communication interface, ride status information to the subscriber, wherein the ride status information comprises at least one of the subscriber preferences, autonomous vehicle capabilities of the group of autonomous vehicles, the safety profile information, the route characteristics, the service provider status, a pickup time of the ride plan, an arrival time of the ride plan, route characteristics of a route of the ride plan, a description of the ride plan, or respective route delays corresponding to the ride plan.
